(19) United States
(12) Patent Application Publication
(10) Pub. No.: US 2024/0078605 A1
(43) Pub. Date: Mar. 7, 2024

(54) A DYNAMIC COMPUTING SYSTEM FOR ASSET MANAGEMENT

(71) Applicant: Rumo LLC, McKinney, TX (US)

(72) Inventor: Rodolfo Juarez Mora, JR., Mckinney, TX (US)

(73) Assignee: Rumo LLC, McKinney, TX (US)

(21) Appl. No.: 17/929,106

(22) Filed: Sep. 1, 2022

(51) Int. Cl. G06Q 40/06; G06Q 40/02

(52) U.S. Cl. CPC G06Q 40/06; G06Q 40/025

(57) ABSTRACT

An asset management system is described. The system may include a receiver configured to receive a plurality of entities' performance information, margin of safety information, and a user information. The user information may include a user asset portfolio. The system may further include a processor configured to calculate a first quality score for each entity based on entity's performance information. The processor may be further configured to calculate a second user portfolio quality score based on the user asset portfolio and the first quality score. Furthermore, the processor may be configured to obtain a trigger signal when a predefined condition associated with the second user portfolio quality score is met. Responsive to receiving the trigger signal, the processor may be configured to determine a recommendation for the user asset portfolio. The system may further include a transmitter configured to transmit the recommendation to a user device.

### TECHNICAL FIELD

The present disclosure relates to a system and method for asset management, and more particularly, to facilitate asset management by decoupling emotions from investment decisions.

### BACKGROUND

Investors often seek to maximize disposable income by investments in real estate, stocks, cryptocurrencies, precious metals, and other investment vehicles. These investments opportunities provide different returns based on the time of investment or redemption, investment value, and relative investment risk.

While seasoned investors may know an appropriate time and value to invest, retail investors rely on news or opinions to make investment decisions. For example, a retail investor investing in stocks or cryptocurrencies may rely on third-party opinions, news articles, or take guidance from friends or colleagues.

Typically, the retail investor has access to a lot of information, based on which the inventor makes an investment decision. While information access may be beneficial, availability of too much information may cause confusion. For example, the retail investor may get overwhelmed with the amount of available information and may not have the experience or knowledge to segregate useful information from noisy investment opinions and biased information. This may result in a bad investment decision or cause the developing investor to make no decision at all. In addition, the retail investor may spend a lot of time sifting through the large amount of available information, which may not be convenient.

In addition, the available information may include author bias, and hence may not always reflect a true picture of an investment opportunity. Furthermore, the retail investor may be influenced by the investment decisions taken by friends or colleagues and may not always perform due diligence before investing. Consequently, the growing investor may make impulsive investment decisions based on emotions, rather than based on thorough intellectual or technical analysis of investment opportunities.

Thus, there exists a need in the industry for a decision-making system and method that provides information using systematic methods that decouple investor emotion from sound financial decision making and can facilitate making informed and wise investment decisions while greatly improving user experience.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts an example an asset management system in accordance with the present disclosure.

FIG. 3 depicts snapshots of an example user asset portfolio in accordance with the present disclosure.

FIG. 4 depicts snapshots of example recommendations for a client user in accordance with the present disclosure.

FIGS. 5A and 5B depict an example entity report in accordance with the present disclosure.

FIG. 6 depicts an example cryptocurrency report in accordance with the present disclosure.

FIG. 7 depicts an example asset management method in accordance with the present disclosure.

### DETAILED DESCRIPTION

### Overview

The present disclosure describes an asset management system to facilitate investment related decision making. The system may be configured to receive financial information and margin of safety information associated with a plurality of public listed companies. The system may be further configured to receive a user asset portfolio from a user. The user asset portfolio may include asset allocation in one or more public listed companies in which the user may have invested or is considering for investment opportunity. The system may calculate a first quality score for each public listed company based on the received financial information, and a second user portfolio quality score based on the one or more public listed companies' first quality scores and the asset allocation. The system may be configured to determine investment related recommendations for the user based on the calculated first and second quality scores, and the margin of safety information. The system may transmit the recommendations to a user device, so that the user may view the recommendations.

In some aspects, the system may determine the recommendations when a predefined condition associated with the second user portfolio quality score is met. The predefined condition may be, for example, when a percentage decrease in the second user portfolio quality score is greater than a first threshold or when the second user portfolio quality score decreases below a second threshold.

Furthermore, the investment related recommendations may include recommendation to modify the asset allocation and/or recommendation to invest in a new company that may not be present in the user asset portfolio.

The present disclosure discloses an asset management system that decouples emotions from investment related decisions. Since the asset management system provides recommendations based on objective data, such as financial information of public listed companies, the system removes subjectivity from investment related decisions. Specifically, the system does not rely on news articles or other similar secondary data sources, which may have author bias, to provide recommendations. Thus, the system provides fact-based investment recommendations to users.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

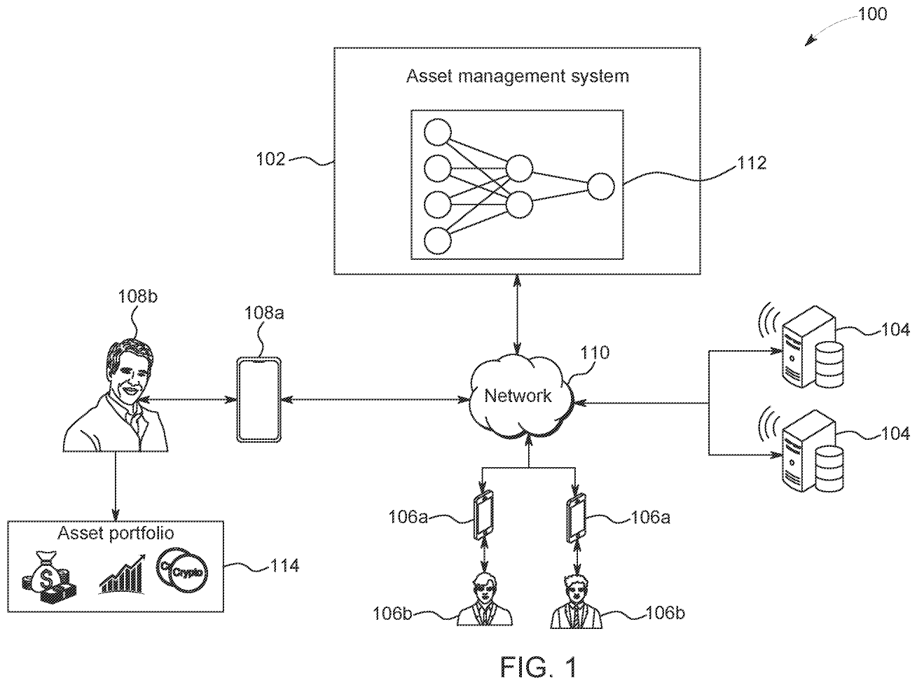

FIG. 1 depicts an example environment 100 in which techniques and structures for providing the systems and methods disclosed herein may be implemented. The environment 100 may include an asset management system 102, a plurality of servers 104, a plurality of user devices 106a, and a client device 108a. The plurality of user devices 106a may be associated with a plurality of users 106b, and the client device 108a may be associated with a client user 108b. In some aspects, the client user 108b may be a part of the plurality of users 106b. In other aspects, the client user 108b may be different from the plurality of users 106b (as shown in FIG. 1).

In some aspects, the asset management system 102, as described herein, can be implemented in hardware, software (e.g., firmware), or a combination thereof. The asset management system 102 may communicatively couple with the plurality of servers 104, the plurality of user devices 106a, and the client device 108a via one or more networks 110 (or a network 110).

The network 110 may be, for example, a communication infrastructure in which the connected devices discussed in various embodiments of this disclosure may communicate. The network 110 may be and/or include the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

In some aspects, the plurality of servers 104 may be associated with a plurality of third-party data sources that may store information related to, for example, stocks, cryptocurrencies, Securities and Exchange Commission (SEC) filings, company financial information, and/or the like. In other words, the plurality of servers 104 may be configured to collate information from stock exchanges, cryptocurrency platforms/databases, and the like, and store the collated information. In some aspects, the plurality of servers 104 may collate and store the information at a predefined frequency, for example, hourly, daily, weekly, monthly, and the like.

The plurality of servers 104 may be configured to transmit, via the network 110, the stored information to the asset management system 102 at a pre-set frequency, e.g., hourly, daily, weekly, and/or the like. In some aspects, the frequency of transmitting the information to the asset management system 102 may be different for different servers. In further aspects, the asset management system 102 may send a request to the plurality of servers 104 to obtain the stored information. In other words, the plurality of servers 104 may transmit the stored information when the plurality of servers 104 receives the request from the asset management system 102.

In one or more aspects, the asset management system 102 may be configured to facilitate investment decision-making for the plurality of users 106b and the client user 108b, based on the information received from the plurality of servers 104. In other words, the asset management system 102 may be configured to provide investment recommendations to the plurality of users 106b and/or the client user 108b, based on the received information.

In some aspects, the asset management system 102 may be an Artificial Intelligence (AI)-based system that may include a neural network model 112. The neural network model 112 may be stored in an asset management system memory (not shown in FIG. 1). The neural network model 112 may be a trained or unsupervised neural network model that may analyze the information received from the plurality of servers 104 using machine learning and natural language processing, which may facilitate determination of investment recommendations for the plurality of users 106b and/or the client user 108b.

In one or more aspects, the neural network model 112 may include electronic data, which may be implemented, for example, as a software component, and may rely on code databases, libraries, scripts, or other logic or instructions for execution of a neural network algorithm by an asset management system processor (not shown in FIG. 1). The neural network model 112 may be implemented as code and routines configured to enable a computing device, such as the asset management system 102, to perform one or more operations (such as determining investment recommendations). In some aspects, the neural network model 112 may be implemented using hardware including a processor, a microprocessor (e.g., to determine investment recommendations), a field-programmable gate array (FPGA), or an application-specific integrated circuit (ASIC). In other aspects, the neural network model 112 may be implemented by using a combination of hardware and software.

Examples of the neural network model 112 may include, but are not limited to, a deep neural network (DNN), a convolutional neural network (CNN), a recurrent neural network (RNN), a CNN-recurrent neural network (CNN-RNN), R-CNN, Fast R-CNN, Faster R-CNN, an artificial neural network (ANN), a Long Short Term Memory (LSTM) network based RNN, CNN+ANN, LSTM+ANN, a gated recurrent unit (GRU)-based RNN, a fully connected neural network, a deep Bayesian neural network, a Generative Adversarial Network (GAN), and/or a combination of such networks. In some aspects, the neural network model 112 may include numerical computation techniques using data flow graphs. In one or more aspects, the neural network model 112 may be based on a hybrid architecture of multiple Deep Neural Networks (DNNs).

In operation, the client user 108b may create an account (e.g., a user account) on the asset management system 102, via the client device 108a, when the client user 108b accesses the asset management system 102 for a first time. The client user 108b may provide client user information to the asset management system 102, while creating the account. The client user information may include, for example, client user profile information and a client user asset portfolio 114. The client user profile information may include, for example, client username, address, annual income, a client user risk tolerance information, a client user investor type profile (e.g., whether the client user 108b is a seasoned investor or a retail investor, large or small investor), and/or the like. The client user asset portfolio 114 may include information associated with the investments made by the client user 108b in cash, one or more stocks, and/or one or more cryptocurrencies. Specifically, the client user 108b may provide asset allocation information to the asset management system 102, while creating the user account.

Responsive to receiving the client user information, the asset management system 102 may create the client user account. The client user 108b may access, via the client device 108a, the asset management system 102, when the asset management system 102 creates the client user account.

In some aspects, the client user 108b may manage assets (e.g., buy/sell stocks or cryptocurrencies in the client user asset portfolio 114) by using the client user account on the asset management system 102. In other aspects, the client user 108b may buy/sell assets on a different platform/system (e.g., not on asset management system 102), and may update the client user asset portfolio 114 on the asset management system 102. In further aspects, the asset management system 102 may update the client user asset portfolio 114, when the client user 108b buy/sell assets on the different platform/system. In this case, the asset management system 102 may communicatively connect (e.g., via the network 110) with the different platform/system, and fetch asset buying/selling information associated with the client user 108b.

In a manner similar to the client user 108b accessing the asset management system 102, the plurality of users 106b may access the asset management system 102, via the respective plurality of user devices 106a, to buy/sell assets and/or update respective asset portfolios on the asset management system 102. In some aspects, the asset management system 102 may track and store user investment activity (e.g., buying or selling of stocks or cryptocurrencies) in the asset management system memory. The asset management system 102 may store the user investment activity at a predefined frequency, e.g., hourly, daily, weekly, etc.

In some aspects, the asset management system 102 may provide investment recommendations to the client user 108b, when the client user 108b uses the asset management system 102 (e.g., when the client user 108b accesses the client user account). In one or more aspects, the asset management system 102 may use the information received from the plurality of servers 104, the user investment activity associated with the plurality of users 106b, and the client user information, to provide investment recommendations to the client user 108b. In particular, the asset management system 102 may use the neural network model 112 to analyze the information received from the plurality of servers 104 and the user investment activity, which may facilitate investment recommendation determination for the client user 108b. In some aspects, the recommendations may include recommendation to modify a percentage of a total asset holding in the client user asset portfolio 114. For example, the asset management system 102 may provide recommendation to the client user 108b to reduce stocks of a Company “A” in the client user asset portfolio 114 from 10% to 5% of the total asset holding. In other aspects, the recommendation may be to invest in a new investment opportunity (e.g., investment in a company stock not included in the client user asset portfolio 114).

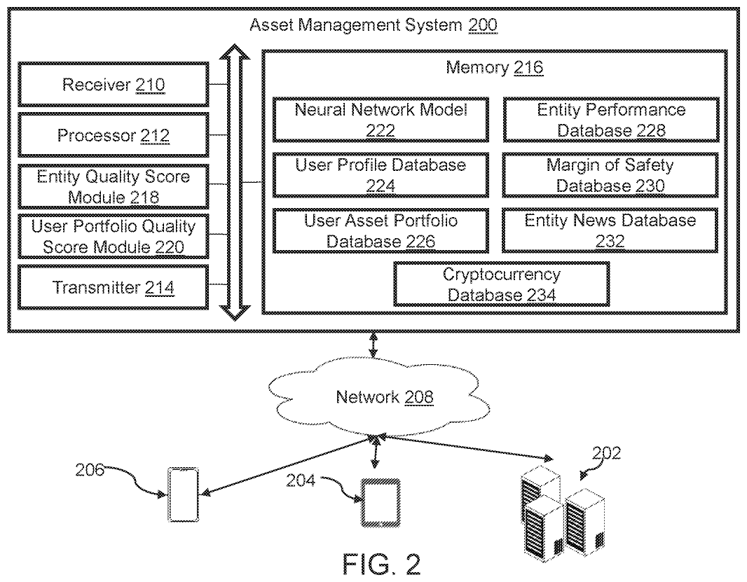

The process and system for determining and providing investment recommendations may be understood in conjunction with FIG. 2.

FIG. 2 depicts an example asset management system 200 in accordance with the present disclosure. In some aspects, the asset management system 200 may be same as the asset management system 102. The asset management system 200 may communicatively connect with a plurality of servers 202 (or servers 202), a plurality of user devices 204 (or user devices 204), and a client user device 206, via a network 208.

In some aspects, the servers 202 may be same as the plurality of servers 104, the user devices 204 may be same as the plurality of user devices 106a, and the client user device 206 may be same as the client device 108a. Furthermore, the network 208 may be same as the network 110. In one or more aspects, the client user device 206 may be associated with a client user (e.g., the client user 108b, not shown in FIG. 2) and the user devices 204 may be associated with a plurality of users (e.g., the plurality of users 106b, not shown in FIG. 2).

The asset management system 200 may include a plurality of components including, but not limited to, a receiver 210, a processor 212, a transmitter 214, a memory 216, an entity quality score module 218, and a user portfolio quality score module 220, which may communicatively couple with each other via a bus. In some aspects, the entity quality score module 218 and the user portfolio quality score module 220 may be stored in the memory 216. In other aspects, the entity quality score module 218 and the user portfolio quality score module 220 may be stored outside the memory 216, as shown in FIG. 2.

The memory 216 may store programs in code and/or store data for performing various asset management system operations in accordance with the present disclosure. Specifically, the processor 212 may be configured and/or programmed to execute computer-executable instructions stored in the memory 216 for performing various asset management system functions in accordance with the disclosure. Accordingly, the memory 216 may be used for storing code and/or data code and/or data for performing operations in accordance with the present disclosure.

In one or more aspects, the processor 212 may be disposed in communication with one or more memory devices (e.g., the memory 216 and/or one or more external databases (not shown in FIG. 2)). The memory 216 can include any one or a combination of volatile memory elements (e.g., dynamic random-access memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.).

The memory 216 may be one example of a non-transitory computer-readable medium and may be used to store programs in code and/or to store data for performing various operations in accordance with the disclosure. The instructions in the memory 216 can include one or more separate programs, each of which can include an ordered listing of computer-executable instructions for implementing logical functions. For example, the memory 216 may include a neural network model 222 (same as the neural network model 112) that may facilitate the asset management system 200 in determining investment recommendations for the asset management system users.

In further aspects, the memory 216 may include a plurality of databases including, but not limited to, a user profile database 224, a user asset portfolio database 226, an entity performance database 228, a margin of safety database 230, an entity news database 232, and a cryptocurrency database 234. In one or more aspects, the processor 212 may use, via the neural network model 222, the information stored in the memory databases, to determine investment recommendation for the users.

In operation, the receiver 210 may be configured to receive user information (associated with the client user 108b and the plurality of users 106b) from the client user device 206 and the user devices 204 respectively, via the network 208. As described above, the user information may include, for example, user profile information and user asset portfolio (same as the client user asset portfolio 114). The user profile information may include, for example, username, address, annual income, user risk tolerance information, user investor type profile (e.g., whether the user is a seasoned investor or a retail investor), and/or the like. In some aspects, the user risk tolerance information may include information that may indicate whether the user prefers short-term investments, long-term investments, high return-high risk investments, average return-low risk investments, and/or the like. In other aspects, the user risk tolerance information may include information that may indicate a maximum investment value/amount that the user may invest in an investment opportunity (e.g., a stock, a cryptocurrency, and/or the like).

In some aspects, the user asset portfolio may include information related to the total investment made by the user (e.g., a total asset holding value), investments made in different investment types (e.g., stocks, bonds, cryptocurrencies, and/or the like), and investments details associated with each investment type. For example, a client user asset portfolio may include asset allocation information indicating that the client user has invested 2,000 units in Company “A” stocks, 3,500 units in Company “B” stocks, and 100 units in cryptocurrency “C”. In another example, if the client user has invested $400 in the Company “A” stocks, and a client user total asset holding value is $1,000, the asset allocation information may indicate that the client user has invested 40% of the total asset holding in the Company “A” stocks.

Responsive to receiving the user information, the receiver 210 may send the information to the memory 216. The memory 216 may store the received user profile information in the user profile database 224, and the user asset portfolio information in the user asset portfolio database 226.

In further aspects, the receiver 210 may receive performance information associated with a plurality of entities from the servers 202. The entities may be, for example, public listed companies or organizations, and the performance information may include publicly listed companies' financial information. In some aspects, one or more servers, from the servers 202, may be associated with stock exchanges and/or SEC filing databases, and may transmit publicly listed companies' financial information to the receiver 210 at a preset frequency (e.g., hourly, daily, weekly, monthly, quarterly, and/or the like). In some aspects, the receiver 210 may be configured to receive the performance information at the preset frequency or based on a trigger event (e.g., when the asset management system 200 transmits a request to the servers 202 to share the performance information). The financial information may include, for example, for each company, a solvency ratio, a profit margin, an operating margin, a return on assets, a return on equity, a debt-to-equity ratio, a valuation ratio, a growth information, a market cap information, a price-earning (PE) ratio, and an earnings per share (EPS). Other financial indicators and metrics are possible, and such options are contemplated herein. In an example, the receiver 210 may receive financial information of Company “A” and Company “B” (in which the client user has invested) from the servers 202, at the preset frequency or when the asset management system 200 sends a request to the servers 202.

Responsive to receiving the plurality of entities' performance information, the receiver 210 may send the performance information to the memory 216, which may store the information in the entity performance database 228.

The receiver 210 may be further configured to receive margin of safety information, for each entity, from the servers 202. A person ordinarily skilled in the art may appreciate that margin of safety is a difference between a fair value of a company's stock and a current/live stock value. For example, if the Company “A” stock's fair value is $6, and the current/live stock value is $4.9, then the margin of safety may be $1.1 or 18.3% of the fair value. The ordinarily skilled person may know that the stock fair value may be calculated based on a ratio of median stock price/value to sale price/value for previous predetermined years (e.g., five years). In addition, the servers 202 may store stock fair values (identified from stock exchanges) for stocks associated with the plurality of entities and may transmit the stock fair values to the receiver 210 at the preset frequency or when the asset management system 200 transmits a request to the servers 202 to share margin of safety information.

Responsive to receiving the margin of safety information, the receiver 210 may send the information to the memory 216, which may store the information in the margin of safety database 230.

In a similar manner, the receiver 210 may be configured to receive a plurality of news articles related to the plurality of entities (e.g., the publicly listed companies) from the servers 202. The news articles may be related to entities' financial performance, and the receiver 210 may send the received news articles to the memory 216. The memory 216 may store the news articles in the entity news database 232.

In further aspects, the receiver 210 may be configured to receive cryptocurrency performance information, associated with a plurality of cryptocurrencies, from the servers 202. The cryptocurrency performance information may include, for example, current/live cryptocurrency value. Responsive to receiving the cryptocurrency performance information, the receiver 210 may send the information to the memory 216, which may store the information in the cryptocurrency database 234.

In some aspects, the processor 212 may be configured to use the information stored in the memory databases, to facilitate the client user in making investment related decisions. Specifically, the processor 212 may use the information to assign objective quality score to each entity (e.g., the public listed companies), and the client user asset portfolio. In particular, the quality scores may be based on entities' financial information and may not be based on opinions or news articles (which may be, for example, biased). The processor 212 may then assist the client user in making investment related decisions that may be based on objective quality scores, rather than based on subjective data sources. Hence, the processor 212 may facilitate the client user to decouple emotions and/or bias from investment decisions. The process of assisting the client user in making investment decisions is described as follows.

In some aspects, the processor 212 may be configured to send a command to the entity quality score module 218 to calculate a first quality score for each entity. The first quality score may be based on the performance information, or the financial information associated with the plurality of entities.

Responsive to receiving the command from the processor 212, the entity quality score module 218 may run the neural network model 222 to analyze the entities' performance information stored in the entity performance database 228 and assign a first quality score to each entity. The neural network model 222 may be a trained/unsupervised neural network model that may analyze the large amount of financial information stored in the entity performance database 228, and the entity quality score module 218 may calculate the first quality score based on the financial information analysis.

In one or more aspects, the first quality score may be based on objective data, such as entity financial strength, profitability, efficiency, growth rate, economic moat, and/or the like. In some aspects, the entity financial strength may be based on interest coverage, debt-to-equity ratio, Altman Z-score, ratio of weighted average cost of capital (WACC) and return on invested capital (ROIC), and the like. The entity profitability may be based on entity operating margin, and operating margin of similar entities, historically (e.g., for the past 10 years). The entity efficiency may be based on return on assets (ROA) and return on equity (ROE) information for the entity, and similar entities, historically. Similarly, entity growth may be based on entity's compounded annual growth rate (CAGR), and the economic moat may be based on entity's profitability and efficiency.

In some aspects, the entity quality score module 218 may assign weights to each objective data described above and may calculate the first quality score for an entity (e.g., the company “A”), based on financial information weighted average for the entity. For example, the entity quality score module 218 may assign the first quality score of 85% to the Company “A”, based on the Company “A” financial information. In an example, a first quality score of 80-100% may indicate that the company may be financially strong, a quality score of 60-80% may indicate that the company may be financially average, 40-60% may indicate that the company might be risky (e.g., to invest in), and a score of less than 40% may indicate a financially unstable company.

A person ordinarily skilled in the art may appreciate that since the entity quality score module 218 calculates the first quality score based on objective financial information, emotional bias is decoupled from the quality score calculation process. In addition, it is to be understood that the examples mentioned above are not intended to be limiting. The ordinarily skilled person may use different score ranges to define a financially strong, average or unstable company, without departing from the present disclosure scope.

In some aspects, the entity quality score module 218 may send the calculated first quality score for each entity to the processor 212. Responsive to receiving the first quality score, the processor 212 may send a command to the user portfolio quality score module 220 to calculate a second user portfolio quality score. For example, the processor 212 may command the user portfolio quality score module 220 to calculate a client user portfolio quality score for the client user asset portfolio 114.

In one or more aspects, responsive to receiving the command from the processor 212, the user portfolio quality score module 220 may fetch the client user asset portfolio 114 from the user asset portfolio database 226. The user portfolio quality score module 220 may determine the client user asset holding from the client user asset portfolio 114, when the user portfolio quality score module 220 receives the client user asset portfolio 114. Responsive to determining the client user asset holding, the user portfolio quality score module 220 may send a request to the entity quality score module 218 or the processor 212, to receive the first quality scores for the entities/companies present in the client user asset portfolio 114. For example, if the user has invested 10% of total asset holding in Company “A” stocks, 25% in Company “B” stocks, 45% in Company “C” stocks, and 20% in Company “D” stocks, the user portfolio quality score module 220 may send the request to the entity quality score module 218 to receive first quality scores of Companies “A”, “B”, “C”, and “D”. Responsive to receiving the request from the user portfolio quality score module 220, the entity quality score module 218 may send the respective first quality scores to the user portfolio quality score module 220.

Responsive to receiving the first quality scores, the user portfolio quality score module 220 may calculate the client user portfolio quality score for the client user asset portfolio 114. In some aspects, the client user portfolio quality score may be based on the respective first quality scores of companies, and percentage asset holding in the client user asset portfolio 114. Continuing with the above example, if the first quality scores of Companies “A”, “B”, “C”, and “D” are 85%, 45%, 60%, and 90% respectively, the user portfolio quality score module 220 may calculate the client user portfolio quality score as 85*10%+45*25%+60*45%+90*20%=64.75%. 10062) A person ordinarily skilled in the art may appreciate that the mathematical formula described above is just an example, and any other mathematical formula may be used to calculate the client user portfolio quality score based on the client user asset portfolio 114 and the individual entities' first quality scores, without departing from the present disclosure scope.

In some aspects, the processor 212 may send respective commands to the entity quality score module 218 to calculate the first quality scores, and to the user portfolio quality score module 220 to calculate the client user portfolio quality score, at a preset frequency (e.g., hourly, daily, weekly, and the like). In further aspects, the processor 212 may be configured to receive a trigger notification/signal from the user portfolio quality score module 220, when a predefined condition associated with the client user portfolio quality score is met. The predefined condition may be met, for example, when a percentage decrease in the client user portfolio quality score is greater than a first threshold, and/or when the client user portfolio quality score decreases below a second threshold. For example, the user portfolio quality score module 220 may be configured to send a trigger notification/signal to the processor 212 when the client user portfolio quality score decreases by over 5% in a day/week, and/or when the client user portfolio quality score decreases below 75%. In some aspects, the asset management system 200 may pre-set the first threshold and/or the second threshold. In other aspects, the client user may set, via the client user device 206, the first threshold and/or the second threshold (e.g., when the client user creates the user account on the asset management system 200).

Responsive to receiving the trigger signal from the user portfolio quality score module 220, the processor 212 may be configured to determine investment recommendations to provide to the client user. In some aspects, the recommendations may include recommendation to modify asset allocation in the entities/companies in which the client user has invested, and/or recommendation to invest in a new company (e.g., a company that may not be present in the client user asset portfolio 114).

In some aspects, the processor 212 may be configured to determine a company or companies in the client user asset portfolio 114, which led to the decrease in the client user portfolio quality score and may then determine investment recommendations for the client user. Continuing the example described above, if the first quality score of Company “C” drops by 20% (e.g., due to weak financial performance), the client user portfolio quality score may drop by over 5% (which may be the first threshold). In this case, the processor 212 may determine a recommendation for the client user to decrease asset holding in the Company “C” from 45% to 25% (for example). Furthermore, the processor 212 may determine recommendation to increase asset holding in the Company “A”, if the first quality score of Company “A” is relatively high or increasing. In some aspects, the processor 212 may determine the number of units (as a total client asset holding percentage) that the client user may decrease or increase, to increase the client user portfolio quality score. For example, the processor 212 may determine that the client user may reduce the asset holding in Company “C” from 45% to 25% and increase the asset holding in Company “A” from 10% to 30%, to increase the client user portfolio quality score.

In some aspects, the processor 212 may determine recommendations to modify asset holding for assets in the client user asset portfolio 114, as described above, based on the first quality scores of companies in the client user asset portfolio 114, and the companies' margin of safety information (that may be stored in the margin of safety database 230). Specifically, the processor 212 may fetch the margin of safety information associated with the companies in the client user asset portfolio 114 and receive the companies' first quality scores from the entity quality score module 218, which may assist the processor 212 to determine recommendations for the client user. For example, the processor 212 may determine recommendation to reduce asset holding in a company (e.g., the company “A”) with a first quality score of 40% and a margin of safety of 5%. The processor 212 may further recommend increasing asset holding in another company (e.g., the company “B”) with a first quality score of 85% and a margin of safety of 30%.

In one or more aspects, the processor 212 may further determine the recommendation based on a client user risk tolerance information (that the processor 212 may fetch from the user profile database 224). For example, if the client user risk tolerance information indicates that the client user may not want to invest in a high-risk investment by over 20% of the total client user asset holding value, the processor 212 may determine recommendation to increase asset holding in a high-risk investment opportunity by not more than 20%. For example, if investment in the Company “B” is a high risk-high return investment opportunity, the processor 212 may not recommend increasing asset holding percentage in Company “B” beyond 20% (even if the first quality score and the margin of safety of Company “B” are high).

In further aspects, the processor 212 may determine recommendation to invest in the new company (e.g., a company that may not be present in the client user asset portfolio 114), based on the new company first quality score, and the user profile information (that the processor 212 may fetch from the user profile database 224). For example, the processor 212 may run the neural network model 222 to determine new entities (e.g., including the new company), from the plurality of entities, that may have the first quality scores above a predefined threshold (e.g., 80%). In addition, the neural network model 222 may identify investment activity trends associated with the plurality of users (e.g., the plurality of users 106b) for the determined new entities, to further shortlist the new entities. In some aspects, the investment activities associated with the plurality of users 106b may be stored the asset management system memory (e.g., the memory 216, as described in FIG. 1). As an example, the neural network model 222 may identify stock price values when the plurality of users 106b historically invested in the new entities' stocks, their return on investment, redemption values, and/or the like, which may assist the neural network model 222 to shortlist the new entities. As an example, the neural network model 222 may screen the entities that may have given low (below a threshold) return of investment to the plurality of users 106b.

From the shortlisted new entities, the processor 212 may identify the new company to recommend to the client user, based on margin of safety information associated with the shortlisted new entities, and the client user profile. For example, if the client user profile indicates that the client user is a retail investor and may not want to invest in companies dealing in Hydrocarbons, the processor 212 may screen the entities that deal in Hydrocarbons. Furthermore, the processor 212 may screen the entities that have margin of safety below a threshold (e.g., 25%).

In other aspects, the processor 212 may provide recommendations to the client user, when the processor 212 identifies a new company that may increase the client user asset portfolio quality score by a predefined percentage (e.g., 5%) if the client user invests in the new company. In this case, the processor 212 may send the recommendations to invest in the new company to the client user, even when the predetermined condition associated with the client user asset portfolio quality score (as described above) is not met.

In further aspects, the processor 212 may determine the number of units (as a total client user asset holding percentage) that the client user may invest in the new company's stocks, which may increase the client user asset portfolio quality score. The processor 212 may determine the number of units based on the new company's margin of safety and the client user risk tolerance information. For example, if the client user does not want to invest more than 20% of the total client user asset holding in a high-risk venture, and the identified new company is a high-risk venture, the processor 212 may not recommend investing more than 20% of the total asset holding in the new company.

In some aspects, the processor 212 may determine the new company (or companies) as new investment opportunities for the client user, by using the parameters described above. A person ordinarily skilled in the art may appreciate that the processor 212 determines the new company based on objective financial data and does not use subjective opinions to determine the recommendation. Thus, the processor 212 decouples emotions from investment recommendations.

Responsive to determining the recommendations (to modify asset holding and/or investment in the new company) and the corresponding investment units for the client user, the processor 212 may transmit the recommendation to the client user device 206. In one or more aspects, the processor 212 may additionally transmit (along with the recommendations) a notification to the client user device 206 indicating that the client user asset portfolio quality score has decreased beyond the first threshold and/or the second threshold. In some aspects, the processor 212 may send the first quality scores associated with the companies in the client user asset portfolio 114, so that the client user may know the companies that caused the drop in the client user asset portfolio quality score.

In one or more aspects, the processor 212 may transmit additional details to the client user device 206. The additional details may include, for example, the client user asset portfolio quality score, the first quality scores associated with the plurality of entities, the margin of safety information, news articles (e.g., only related to financial information) related to the companies in the client user asset portfolio 114 and/or the new company, etc. In some aspects, the processor 212 may fetch the news articles from the entity news database 232, which may assist the processor 212 to transmit the news articles to the client user device 206.

In some aspects, the processor 212 may transmit the notification, the recommendations, and the additional details to the client user device 206 via the transmitter 214.

Responsive to receiving the notification, the recommendations and the additional details, the client user device 206 may display the received details on a client user device display, for the client user to view. The client user may then take informed and intellectual investment decisions, by using the information shared by the processor 212.

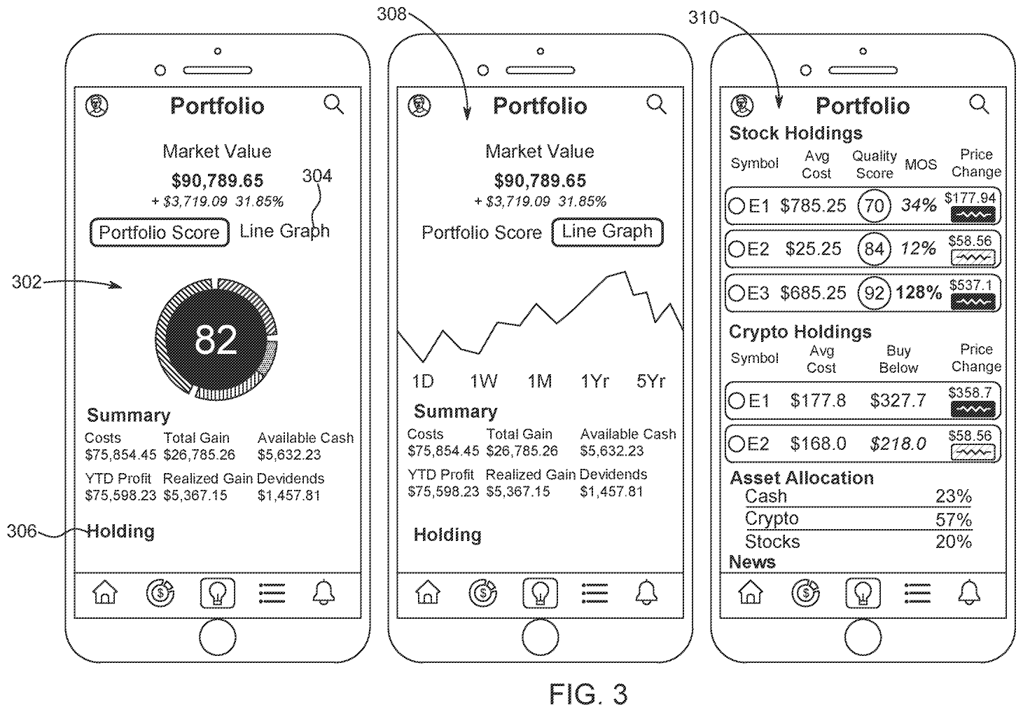

Snapshots depicting the information display on the client user device display are shown in FIGS. 3-6.

FIG. 3 depicts snapshots of an example user asset portfolio in accordance with the present disclosure. In particular, FIG. 3 depicts snapshots of a client user asset portfolio that may be displayed on the client user device 206, based on the details provided by the processor 212.

A snapshot 302 depicts a client user portfolio quality score snapshot. As shown in the snapshot 302, the client user may have the client user portfolio quality score of 82%. The snapshot 302 further shows a total client user asset holding market value and summary (e.g., costs, total gain, available cash, YTD profit, and/or the like).

In addition, the snapshot 302 shows a line graph icon 304 and a holding icon 306.

Clicking on the line graph icon 304 may change the client user device display to a view shown as a snapshot 308. The snapshot 308 depicts a line graph of a client user asset market value with respect to time. Specifically, the snapshot 308 shows a change in the client user asset market value over time.

Furthermore, clicking on the holding icon 306 may change the client user device display to a view shown as a snapshot 310. The snapshot 310 depicts client user asset portfolio holding details. For example, the snapshot 310 depicts the average cost, the first quality scores, margin of safety (MOS), and the price change information, for the companies present in the client user asset portfolio (e.g., the company stocks in which the client user may have invested). Furthermore, the snapshot 310 depicts a cryptocurrency holdings summary, and an asset holding bifurcation (e.g., 23% in cash, 57% in cryptocurrency, and 20% in stocks).

In some aspects, the details shown in the snapshots 302, 308, and 310, may change dynamically, based on changes in the companies and/or cryptocurrencies' performance information (e.g., financial performance). The processor 212 may also dynamically change the client user portfolio quality score and the companies' first quality scores (associated with the companies that are present in the client user asset portfolio), based on the changes in the companies' performance information, and display updated scores on the client user device 206.

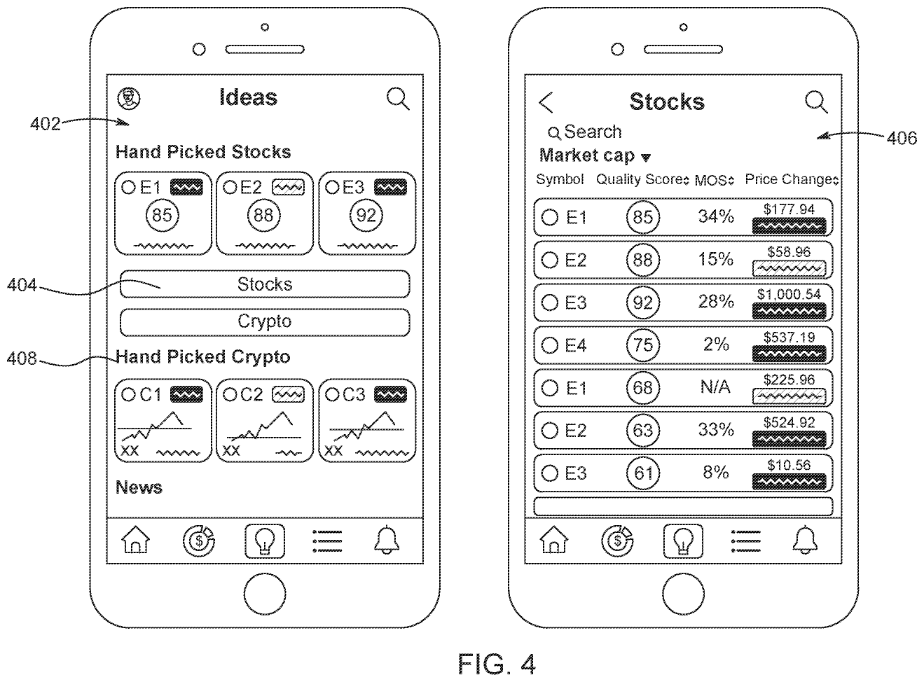

FIG. 4 depicts snapshots of example recommendations for the client user in accordance with the present disclosure. In particular, FIG. 4 depicts snapshots of new company recommendations that may be displayed on the client user device 206, based on the recommendations determined by the processor 212.

Specifically, as described in conjunction with FIG. 2, the processor 212 may determine and recommend new companies (e.g., the companies that may not be present in the client user asset portfolio) in which the client user may invest. A snapshot 402 depicts three recommended companies “E1”, “E2” and “E3”, and their corresponding first quality scores, that may be displayed on the client user device 206. In one or more aspects, the processor 212 may further provide a revised client user portfolio quality score (not shown in FIG. 4) corresponding to each recommended company “E1”, “E2”, and “E3”. The revised client user portfolio quality score may depict a percentage increase in the client user portfolio quality score that may happen if the client user invests in one or more recommended companies “E1”, “E2”, and/or “E3”. In some aspect, the revised client user portfolio quality score may be based on recommended units to invest for each recommended company “E1”, “E2”, and “E3”.

The client user device 206 may also provide an option to the client user to view the first quality scores of additional companies that the processor 212 may not have recommended. For example, the client user may click on a stocks icon 404 and view the first quality scores (and other details) of additional companies. In some aspects, responsive to clicking on the stocks icon 404, the client user device display may change to a view shown as a snapshot 406. The snapshot 406 depicts the first quality scores of a plurality of companies, and their MOS and price change information.

In some aspects, the processor 212 may also determine and recommend cryptocurrencies in which the client user may invest. In one or more aspects, the processor 212 may determine the cryptocurrency recommendations based on a current/live cryptocurrency price, the user risk tolerance information, and the user investor type profile.

The processor 212 may send the recommended cryptocurrencies to the client user device 206, and the client user device 206 may display the recommended cryptocurrencies on the client user device display, as shown in an icon 408.

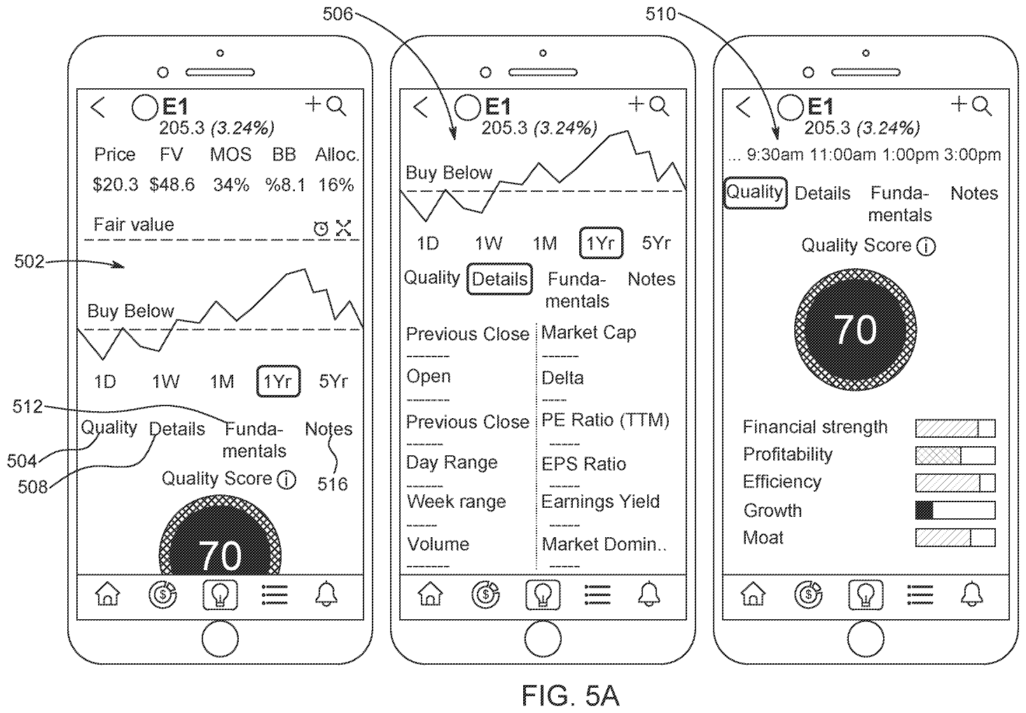

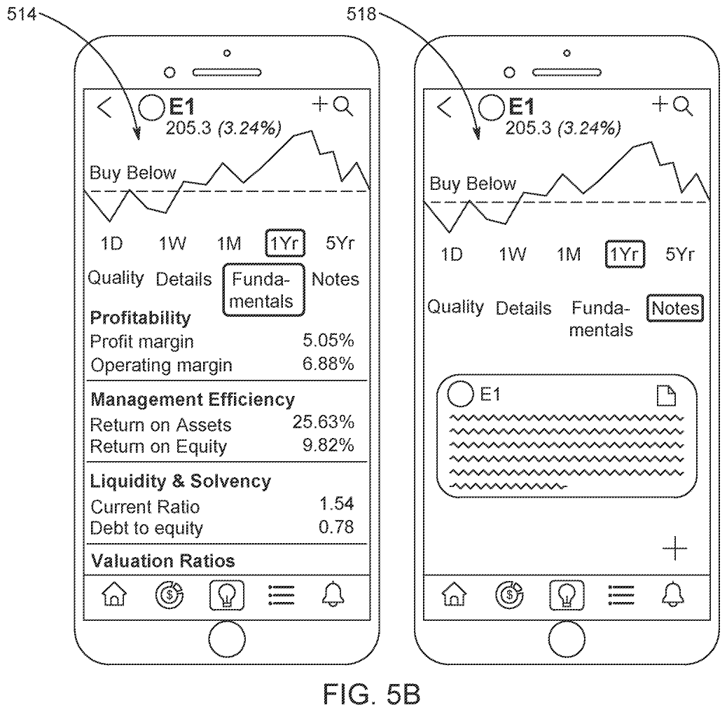

FIGS. 5A and 5B depict an example entity report in accordance with the present disclosure. In particular, FIGS. 5A and 5B depict an entity report of a company “E1”. The company “E1” may be a company in the client user asset portfolio (as shown in the snapshot 310), or a recommended new company (as shown in the snapshot 402) in which the client user may invest.

The client user may view the company “E1” entity report by clicking on the company name, in the snapshot 310 or the snapshot 402. Responsive to receiving the client user click, the client user device display may change to a view shown as a snapshot 502. The snapshot 502 depicts a company “E1” stock performance summary, and the company “E1” first quality score. As shown in the snapshot 502, the client user device 206 may display a company “E1” stock fair value price, a buy below price, and live/intraday stock price (shown as a line graph). The processor 212 may calculate the buy below price for the company “E1” stock based on a target margin of safety information. For example, if the target margin of safety information (which may be pre-set by the asset management system 200, or may be provided by the client user) is 40%, the processor 212 may calculate the company “E1” buy below price as being 40% less than the company “E1” stock fair value price.

In further aspects, the client user may click on a quality icon 504, and view the company “E1” first quality score details. Responsive to receiving the client user click on the quality icon 504, the client user device display may change to a view shown as a snapshot 510. The snapshot 510 depicts the company “E1” performance information details, for example, financial strength, profitability, efficiency, growth, economic moat, and/or the like.

In some aspects, the client user may click on a details icon 508, and view the company “E1” stock details. Responsive to receiving the client user click on the details icon 508, the client user device display may change to a view shown as a snapshot 506. The snapshot 506 depicts the stock details, for example, previous close details, market cap, PE ratio, and the like.

Furthermore, the client user may click on a fundamentals icon 512, and view the company “E1” financial fundamental details. Responsive to receiving the client user click on the fundamentals icon 512, the client user device display may change to a view shown as a snapshot 514 in FIG. 5B. The snapshot 510 depicts the company “E1” financial fundamentals details, for example, profit margin, operating margin, return on assets, return on equity, liquid, and solvency details, and/or the like.

In addition, the client user may add notes corresponding to client user comments associated with the company “E1” by clicking on a notes icon 516. Responsive to receiving the client user click on the notes icon 516, the client user device display may change to a view shown as a snapshot 518 in FIG. 5B. As shown in the snapshot 518, the client user may add notes corresponding to the company “E1” (or any other note), and may save the note and/or share the note with other users (via respective user devices).

A person ordinarily skilled in the art may appreciate that by using the views shown in FIGS. 5A and 5B, the client user may understand details of a company's performance (e.g., financial information) and its first quality score, and may accordingly take intellectual investment decisions. The details do not include subjective or opinionated information, and thus emotions are decoupled from the investment decisions.

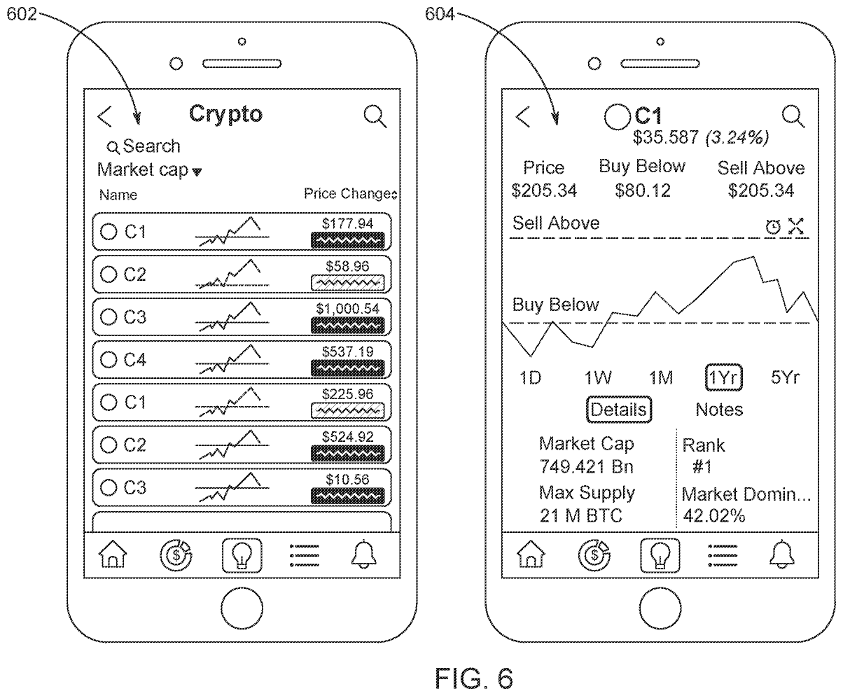

FIG. 6 depicts an example cryptocurrency report in accordance with the present disclosure. In particular, similar to the snapshot 406 (which relates to company stocks), the client user device 206 may display a view depicting performance details of cryptocurrencies, as shown in FIG. 6. For example, when the client user clicks on “Crypto” icon in the snapshot 402, the client user device display may change to a view shown as a snapshot 602.

The snapshot 602 depicts current/live intraday price, and price change details of cryptocurrencies. By clicking on a particular cryptocurrency, for example cryptocurrency “C”, the client user may view the cryptocurrency performance information details, as shown in a snapshot 604. The snapshot 604 depicts details such as, sell above price, buy below price, current/live intraday price, market cap, and/or the like. In some aspects, the client user may take investment decisions to buy or sell in a particular cryptocurrency, based on the cryptocurrency report shown in FIG. 6.

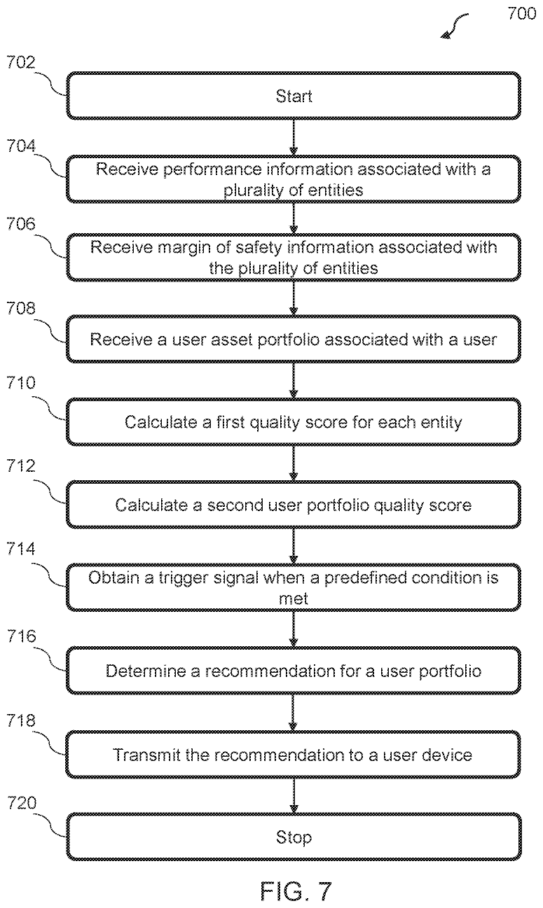

FIG. 7 depicts an example asset management method 700 in accordance with the present disclosure. FIG. 7 may be described with continued reference to prior figures, including FIGS. 1-6. The following process is exemplary and not confined to the steps described hereafter. Moreover, alternative embodiments may include more or less steps that are shown or described herein and may include these steps in a different order than the order described in the following example embodiments.

Referring to FIG. 7, at step 702, the method 700 may commence. At step 704, the method 700 may include receiving, by the receiver 210, performance information associated with a plurality of entities. As described above, the entities may be public listed companies. The performance information may include the public listed companies' financial information. At step 706, the method 700 may include receiving, by the receiver 210, margin of safety information associated with the plurality of entities. In some aspects, the receiver 210 may receive the performance information and the margin of safety information from the servers 202.

At step 708, the method 700 may include receiving, by the receiver 210, a user asset portfolio associated with a user. In some aspects, the receiver 210 may receive the user asset portfolio from a client user, via a client user device (e.g., the client user device 206).

Responsive to receiving the performance information, the user asset portfolio, and the margin of safety information, the receiver 210 may send the user asset portfolio and the information to the memory 216 for storage purpose. The processor 212 may then fetch/obtain the user asset portfolio and the information from the memory 216.

At step 710, the method 700 may include calculating, by the processor 212, a first quality score for each entity. As described in conjunction with FIG. 2, the processor 212 may command the entity quality score module 218 to calculate the first quality score based on entities' financial information (or performance information).

At step 712, the method 700 may include calculating, by the processor 212, a second user portfolio quality score (e.g., a client user portfolio quality score). As described above, the processor 212 may command the user portfolio quality score module 220 to calculate the client user portfolio quality score based on respective first quality scores of companies present in a client user asset portfolio, and a percentage asset holding of each entity in the client user asset portfolio.

At step 714, the method 700 may include obtaining, via the processor 212, a trigger signal when a predefined condition associated with the client user portfolio quality score is met. As described above, the processor 212 may receive the trigger signal from the user portfolio quality score module 220, when a percentage decrease in the client user portfolio quality score is greater than a first threshold, and/or when the client user portfolio quality score decreases below a second threshold.

At step 716, the method 700 may include determining, by the processor 212, a recommendation for the client user asset portfolio, in response to receiving the trigger signal. In some aspects, the recommendation may include modifying the client user asset allocation and/or recommendation to invest in a new company. The process of determining the recommendation is described in conjunction with previous figures.

At step 718, the method 700 may include transmitting, by the transmitter 214, the recommendation to a user device to display the recommendation. At step 720, the method 700 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A computing system for asset management comprising:
a receiver configured to:
receive a performance information associated with a plurality of entities;
receive a user asset portfolio that comprises an asset allocation in at least one entity;
receive a margin of safety information associated with the plurality of entities;
one or more processors communicatively coupled to the receiver, wherein the one or more processors is configured to:
obtain the performance information, the user asset portfolio, and the margin of safety information from the receiver;
calculate a first quality score for each entity based on the performance information;
calculate a second user portfolio quality score based on the asset allocation and the first quality score associated with the at least one entity;
obtain a trigger signal when a predefined condition associated with the second user portfolio quality score is met;
determine a recommendation for the user asset portfolio when the trigger signal is obtained, and
wherein the recommendation comprises modifying the asset allocation,
wherein the recommendation is determined based on the first quality score, and the margin of safety information associated with the at least one entity; and
a transmitter configured to transmit the recommendation to a user device to display the recommendation.

2. The computing system of claim 1, wherein the receiver is further configured to receive a user risk tolerance information.

3. The computing system of claim 2, wherein the recommendation is further based on the user risk tolerance information.

4. The computing system of claim 2, wherein the one or more processors is further configured to:
identify a second entity, from the plurality of entities, based on the first quality score associated with the second entity, and a user profile;
calculate second entity asset units, wherein the second entity asset units are calculated based on a second entity margin of safety information and the user profile; and
recommend the second entity asset units to a user.

5. The computing system of claim 4, wherein the transmitter is further configured to transmit second entity asset units recommendation to the user device.

6. The computing system of claim 4, wherein the one or more processors is further configured to determine news articles associated with the at least one entity or the second entity, and the transmitter is further configured to transmit the news articles to the user device.

7. The computing system of claim 1, wherein the performance information and the margin of safety information are received from a server, and the user asset portfolio is received from a user via the user device.

8. The computing system of claim 1, wherein the performance information comprises at least one of: a solvency ratio, a profit margin, an operating margin, a return on assets, a return on equity, a debt-to-equity ratio, a valuation ratio, a growth information, a market cap information, a price-earning (PE) ratio, and an earnings per share (EPS).

9. The computing system of claim 1, wherein the user asset portfolio further comprises asset allocation in cash or at least one cryptocurrency.

10. The computing system of claim 1, wherein the predefined condition is met when a percentage decrease in the second user portfolio quality score is greater than a first threshold or when the second user portfolio quality score decreases below a second threshold.

11. An asset management method comprising:
obtaining, by a processor, a performance information associated with a plurality of entities;
obtaining, by the processor, a user asset portfolio that comprises an asset allocation in at least one entity;
obtaining, by the processor, a margin of safety information associated with the plurality of entities;
calculating, by the processor, a first quality score for each entity based on the performance information;
calculating, by the processor, a second user portfolio quality score based on the asset allocation and the first quality score associated with the at least one entity;
obtaining, by the processor, a trigger signal when a predefined condition associated with the second user portfolio quality score is met;
determining, by the processor, a recommendation for the user asset portfolio when the trigger signal is obtained,
wherein the recommendation comprises modifying the asset allocation, and
wherein the recommendation is determined based on the first quality score, and the margin of safety information associated with the at least one entity; and
transmitting, by a transmitter, the recommendation to a user device to display the recommendation.

12. The asset management method of claim 11 further comprising obtaining a user risk tolerance information.

13. The asset management method of claim 12, wherein the recommendation is further based on the user risk tolerance information.

14. The asset management method of claim 12 further comprising:
identifying, by the processor, a second entity, from the plurality of entities, based on the first quality score associated with the second entity, and a user profile; and
calculating, by the processor, a second entity asset units, wherein the second entity asset units are calculated based on a second entity margin of safety information and the user profile; and
recommending, by the processor, the second entity asset units to a user.

15. The asset management method of claim 14 further comprising transmitting, by the transmitter, second entity asset units recommendation to the user device.

16. The asset management method of claim 11, wherein the performance information comprises at least one of: a solvency ratio, a profit margin, an operating margin, a return on assets, a return on equity, a debt-to-equity ratio, a valuation ratio, a growth information, a market cap information, a price-earning (PE) ratio, and an earnings per share (EPS).

17. The asset management method of claim 11, wherein the predefined condition is met when a percentage decrease in the second user portfolio quality score is greater than a first threshold or when the second user portfolio quality score decreases below a second threshold.

18. A non-transitory computer-readable storage medium in a distributed computing system, the non-transitory computer-readable storage medium having instructions stored thereupon which, when executed by a processor, cause the processor to:
obtain a performance information associated with a plurality of entities;
obtain a user asset portfolio that comprises an asset allocation in at least one entity;
obtain a margin of safety information associated with the plurality of entities;
calculate a first quality score for each entity based on the performance information;
calculate a second user portfolio quality score based on the asset allocation and the first quality score associated with the at least one entity;
obtain a trigger signal when a predefined condition associated with the second user portfolio quality score is met;
determine a recommendation for the user asset portfolio when the trigger signal is obtained, and
wherein the recommendation comprises modifying the asset allocation,
wherein the recommendation is determined based on the first quality score, and the margin of safety information associated with the at least one entity; and
transmit the recommendation to a user device to display the recommendation.

19. The non-transitory computer-readable storage medium of claim 18, having further instructions stored thereupon to obtain a user risk tolerance information.

20. The non-transitory computer-readable storage medium of claim 19, wherein the recommendation is further based on the user risk tolerance information.
